(19) United States
(12) Patent Application Publication
(10) Pub. No.: US 2006/0048219 A1
(43) Pub. Date: Mar. 2, 2006

(54) Secure private information transmission program and secure private information receiving apparatus

(75) Inventor: Tatsuya Kita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/992,803

(22) Filed: Nov. 22, 2004

(30) Foreign Application Priority Data
Aug. 26, 2004 (JP) 2004-247244

(51) Int. Cl. G06F 15/16

(52) U.S. Cl. 726/14

(57) ABSTRACT

A secure private information transmission program readable by a computer, comprises the steps of: receiving first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and determining screen specifying information which specifies the second transition screen based on the branching condition and information inputted on the first transition screen.

### BACKGROUND OF THE INVENTION

The present invention relates to a secure private information transmission program and a secure private information receiving apparatus.

The recent popularization of the Internet has set up an environment that enables individuals to file various personal applications via the Web (World Wide Web). On the other hand, considering the fact that the Internet was originally developed for openly exchanging information, security measures taken at present are not sufficient to prevent leakage of private information through the Internet.

SSL encoding and other current security measures are capable of preventing electronic interception of private information by a third party along communication paths. However, these measures are helpless against eavesdropping and spoofing once a device that has been used to file such applications falls under control of the eavesdropper. This is one of the situations exist that carry the risk of leakage of private information.

Basically, with the exception of social hacking (meaning untechnical eavesdropping and other similar acts such as sneaking a look at somebody's password while it is entered), most information leakage takes place through electronic interception of the contents of communications between client PCs (personal computers) of submitters and a recipient server.

FIG. 8 shows an example of entering private information on a Web page in order to file a change of address. The submitter has to input necessary information while shifting between plural pages of the Web and has to send his/her personal information repeatedly each time the next page is opened, which lowers the security level.

Better security can be achieved if the entirety of necessary private information is entered on one page of the Web site for a single transmission. This is because the window of opportunity for electronic interception is limited to the single transmission from the client PC to the server.

To eavesdrop on this unidirectional transmission from the client PC to the server, the eavesdropper needs to intercept information sent from the client PC at a point along the path and analyze the intercepted information. It is therefore indispensable to install along the transmission path a tap, which is not much useful when SSL encoding or the like is applied.

However, users may find it difficult to enter all information correctly on one page when the amount of information to be inputted is large. To help users accurately enter all information at once, a wizard format is usually employed which switches between plural input pages, assisting users in shifting from one page to another (input assistance). Thus a user guidance wizard is utilized to lighten the burden of users.

In general, past input data is discarded when leaving one page for another with a Web browser. A wizard format therefore employs one of methods shown in FIGS. 9 to 11 in order to allow users to shift through pages while retaining data inputted on the previous pages.

(1) FIG. 9 is an explanatory diagram showing a method of “storing information in Cookies” for storing information in a client PC. (2) FIG. 10 is an explanatory diagram showing a “session management” method for keeping information on a server. (3) FIG. 11 is an explanatory diagram showing an “application” method in which a client application (program) is downloaded and executed.

(1) FIG. 9 is explained first. The method of “storing information in Cookies” is very easy and therefore is employed widely. According to this method, private information is transmitted via a communication line at least twice, namely, once to the server and once back to the client PC to be stored in the client PC. The private information is vulnerable to interception on the way back.

Although SSL encoding makes it difficult for a third party on the path to intercept the private information, the information received by the client PC that has transmitted the private information can be recorded in “packet capture” software or the like if such software is installed in the client PC without the knowledge of the owner/user of the client PC.

In addition, in the case where a Cookie expiration date is set, the private information and other information are stored as a file in the client PC, which leaves the contents of the stored file accessible by any unspecified user of the client PC that retains the Cookies.

For instance, Internet cafes and other similar places where a large number of unspecified users share the same client PC are liable to leakage of private information. Combined with this, there is a fact that more pages to shift through under the guidance of a wizard format present more opportunities for electronic interception.

(2) The “session management” method as the one shown in FIG. 10 is employed in services of certain scales that are on the larger side. The method is to keep private information on the server instead of client PCs and therefore is less liable to leakage of private information than the method of FIG. 9.

According to the “session management” method, each client PC is provided with an identification code called a “session ID”, which enables the server to recognize which data it stores is about which client PC.

A client PC sends its own ID to receive permission to access the information it sent in the past on a page after page shifting. The ID, however, is vulnerable to electronic interception for the same reason as in the method of “storing information in Cookies” of FIG. 9.

If one of the IDs falls into the hands of a third party, the third party can use the intercepted ID to access the server from another client PC and have the client PC display the information of the legitimate owner of the intercepted ID through impersonation.

The “session management” method, in which the server stores private information unlike the method of “storing information in Cookies” of FIG. 9, brings no fear of private information being leaked directly from a client PC.

The crucial problem of the “session management” method is that, once a session ID is leaked, a third party can impersonate and obtain private information in the server using a client PC that is not the one having the leaked ID. This results from a problem called “cross-site scripting vulnerabilities”, which allow leakage of session IDs.

Interception of a session ID by a third party on a path between a client PC and the server can be prevented by SSL encoding or the like that makes the session ID decipherable only to the client PC and the server. Still, a third party can decode an encoded session ID by directly manipulating the client PC that is communicating the ID, and the problem of leakage of private information from public client PCs such as those in Internet cafes remains unsolved.

(3) Lastly, the “application method” as the one shown in FIG. 11 is explained. The method suffers from a problem of “interception upon communication with the server”. A solution to this problem is to have a client PC execute a filing program downloaded in the form of an application and send back only data that are inputted with the use of the filing program.

The “application” method involves a one-time, unidirectional communication with the server and therefore has a low risk of leaking private information. On the other hand, with the “application” method, a change in the form of a Web page for filing calls for a complete makeover of the application.

In other words, the “application” method has non-security related problems including reduced conveniences, such as being deprived of an option of obtaining the latest information via the Internet, and an increase in number of development steps.

In conclusion, those methods have either a risk of leaking private information or a problem of increased development/maintenance steps.

Given below is an existing similar invention, which fails to solve the aforementioned problems.

Patent document 1 discloses an invention related to an article purchasing system and the like for Internet shopping in which private information such as user's name, address, telephone number and bank account number is inputted only once. According to Patent document 1, a user who has neither an ID number nor a password enters his/her personal information only once upon making his/her first time purchase.

[Patent document 1] JP2001-344478 A

The root of the problem of information leakage described above resides in mutual communications between a client PC and the server.

The risk of information leakage can be avoided by filing in accordance with the application providing method of FIG. 11, which minimizes such mutual communications. In return, such benefits as promptness that are available to services provided on the Web are lost to the “application” method since page information to be displayed is contained in the application itself. Accordingly, the “application” method is not suitable for services that require promptness.

### SUMMARY OF THE INVENTION

The present invention has been made in view of the above, and an object of the present invention is therefore to provide a secure private information transmission program and a secure private information reception program, apparatus and method, by which it is possible to minimize (reduce) the amount of information communicated between a client PC and a server and to reduce the risk of interception of the communicated information.

To achieve the object described above, according to the present invention, there is provided a secure private information transmission program characterized by having a computer function as: receiving means for receiving first transition screen information and screen transition information, the first transition screen information being for displaying a first transition screen prior to screen transition, the screen transition information containing a branching condition and screen specifying information which specifies a second transition screen to be shifted after the branching condition on the first transition screen; and determining means for determining screen specifying information which specifies the second transition screen based on the branching condition and information inputted on the first transition screen.

Further, according to the present invention, there is provided a secure private information reception program characterized by having a computer function as: transmitting means for transmitting first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and receiving means for receiving screen specifying information which specifies the second transition screen determined based on the branching condition and information inputted on the first transition screen.

According to the present invention, (i) a first transition screen is received separately from (ii) screen transition information containing a branching condition and screen specifying information, which specifies a second transition screen to be shifted after satisfying the branching condition on the first transition screen.

Changing the first transition screen itself has conventionally been needed in the case where the branching condition and information of the second transition screen to be shifted after satisfying the branching condition on the first transition screen are buried in the first transition screen. In contrast, the present invention makes it possible to modify the screen transition information without changing the first transition screen, and thus facilitates modification of the branching condition and the second transition screen information.

Moreover, sending filing information each time the screen specifying information is transmitted is avoided by sending only the screen specifying information that is determined by the determining means to be sent. The invention thus minimizes the number of times private information is sent even when private information is inputted on plural transition screens.

### DESCRIPTION OF THE DRAWINGS

FIG. 1 is an explanatory diagram illustrating a procedure that is executed by a secure private information transmission program and secure private information reception program according to the present invention.

FIG. 2 is a screen transition diagram showing a shift between transition screens displayed on a client.

FIG. 3 is a screen transition diagram showing a shift between transition screens displayed on a client.

FIG. 4 is an explanatory diagram showing an example of information sent from a server to a client when a screen A, which is the initial screen, is displayed.

FIG. 5 is an explanatory diagram showing an example of information sent from the server to the client when a screen B, which is a transition screen, is displayed.

FIG. 6 is an explanatory diagram showing an example of information sent from the server to the client when a screen C, which is a transition screen, is displayed.

FIG. 7 is a flow chart showing a basic processing procedure of the present invention.

FIG. 8 is a diagram showing an example of inputting private information on a Web page in order to file “a change of address”.

FIG. 9 is an explanatory diagram showing a method of “storing information in Cookies” for storing information in a client PC.

FIG. 10 is an explanatory diagram showing a “session management” method for keeping information on a server.

FIG. 11 is an explanatory diagram showing an “application” method in which a client application (program) is downloaded and executed.

### DETAILED DESCRIPTION OF THE INVENTION

The best mode of carrying out the present invention is described with reference to the accompanying drawings.

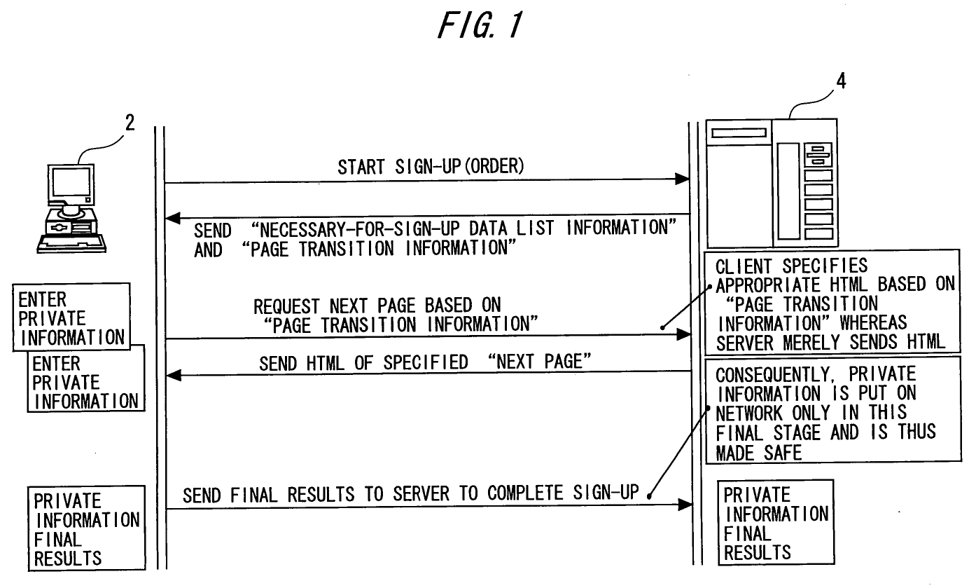

FIG. 1 is an explanatory diagram illustrating a procedure that is executed in a secure private information transmission program and secure private information reception program according to the present invention.

A secure private information transmission program and secure private information reception program according to this embodiment of the present invention are programs respectively installed in apparatuses shown in FIG. 1, a client 2, which is a user terminal, and a server 4 (secure private information receiving apparatus). The client 2 and the server 4 are connected with each other via a communication line such as the Internet.

The client 2 is a computer in which a program can be installed and executed, for example, a portable terminal such as a PDA, a cellular phone or a notebook computer, or a desktop computer. The server 4 is a computer accessible by plural clients 2, 2, . . . via a communication line.

(1) The client 2 executes the secure private information transmission program to request necessary-for-sign-up (necessary-for-application) data list information and page transition information from the server 4 to “start sign-up (application)”. The server 4 executes the secure private information reception program to send the necessary-for-sign-up data list information and the page transition information to the client 2.

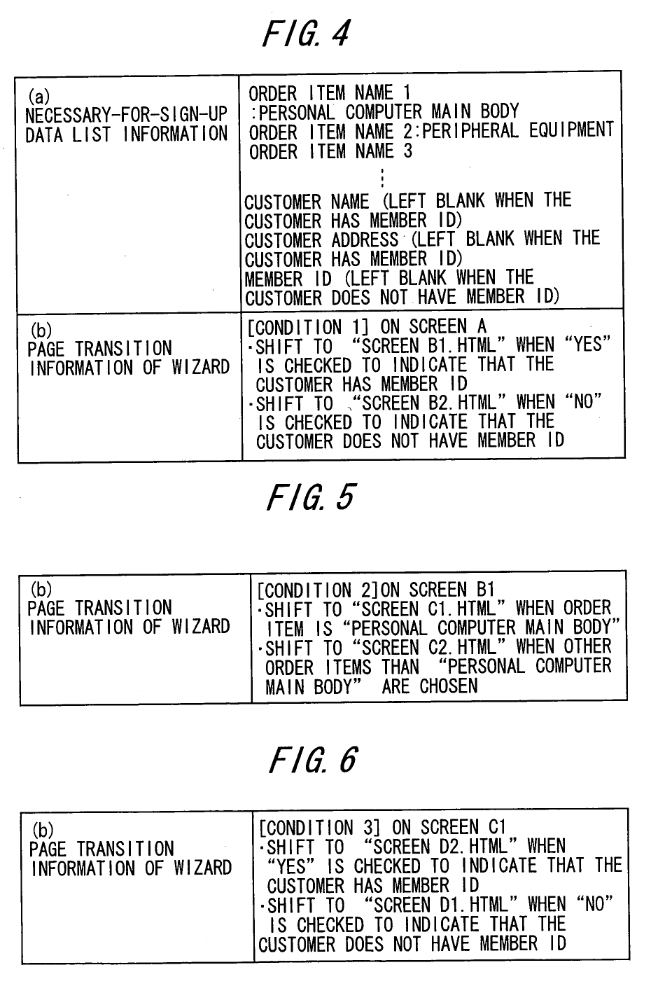

The page transition information (screen transition information) here is information shown in (b) of FIG. 4. The page transition information contains branching condition and screen specifying information, which specifies a transition screen to be shifted after satisfying the branching condition (example: ScreenB1.html). In short, the screen specifying information is address information (URL) of the transition screen or the like.

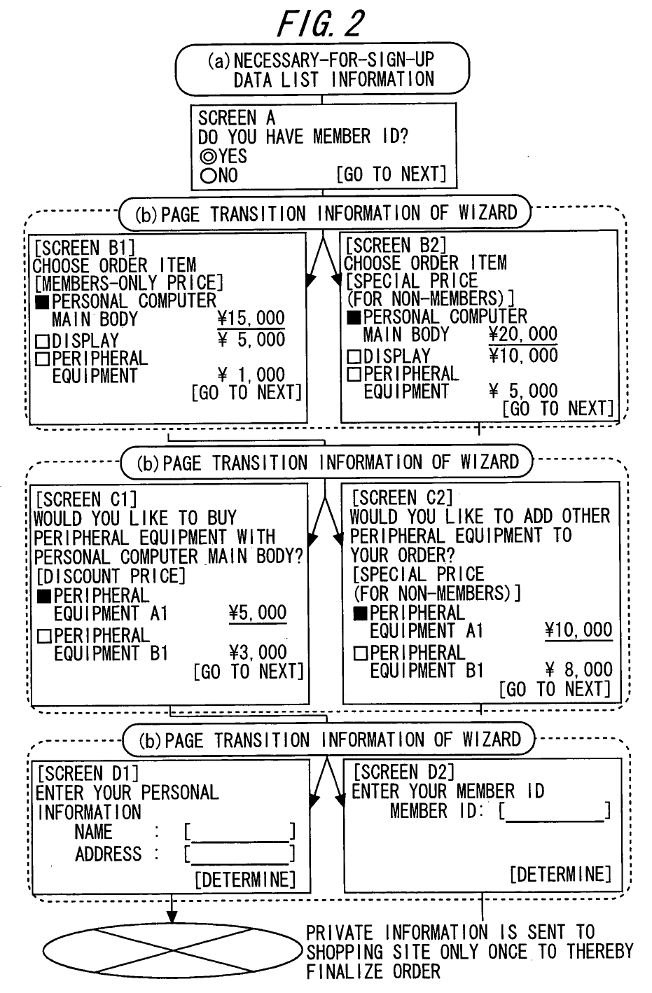

In an example shown in (b) of FIG. 4, the branching condition is whether the client 2 has a member ID or not and the screen specifying information is “ScreenB1.html” and “ScreenB2.html”. Screens displayed at “ScreenB1.html” and “ScreenB2.html” are transition screens. The transition screens are a “screen B1” and “screen B2” displayed on a display of the client 2 as shown in FIG. 2.

The page transition information the client 2 requests from the server 4 at “start sign-up” contains not a transition screen but “screen specifying information” for specifying a transition screen. The necessary-for-sign-up data list information and the page transition information are sent from the server 4 by executing a program such as Java (registered trademark) Servlet. A transition screen, on the other hand, is sent from a Web server by an HTTP request. In other words, the server 4 uses different procedures to send page transition information and transition screens.

The necessary-for-sign-up data list information is information shown in (a) of FIG. 4. The necessary-for-sign-up data list information carries a list of items to be entered through the client 2. Information entered by selecting from options or in a descriptive manner with a mouse, keyboard and the like of the client 2 is recorded in the necessary-for-sign-up data list information.

(2) When the information contained in the page transition information which is received from the server 4 is of an initial screen, the client 2 requests the next page (transition screen) from the server 4. In other words, the page transition information immediately after sign-up is started contains a branching condition for requesting the initial screen and screen specifying information that specifies the initial screen (transition screen).

In order to receive the transition screen from the server 4, the client 2 sends the screen specifying information to the server 4 following the branching condition. The server 4 sends, to the client 2, the transition screen that is specified by the screen specifying information received from the client 2.

After sign-up is started, the page transition information shown in (b) of FIG. 4 to (b) of FIG. 6 is sent at once from the server 4 to the client 2. Alternatively, the client 2 may request the server 4 for page transition information concerning a transition screen upon transmission of screen specifying information from the client 2 to the server 4. In the case where page transition information is requested from the server 4 each time the client 2 sends screen specifying information to the server 4, a change in a transition screen requires modification of only page transition information that is related to the changed transition screen.

(3) Private information and other information inputted on the received plural transition screens are recorded in the necessary-for-sign-up data list information. Upon completion of inputting the necessary-for-sign-up data list information, the client 2 sends the necessary-for-sign-up data list information to the server 4. The necessary-for-sign-up data list information is deleted from the client 2 when the secure private information transmission program is ended.

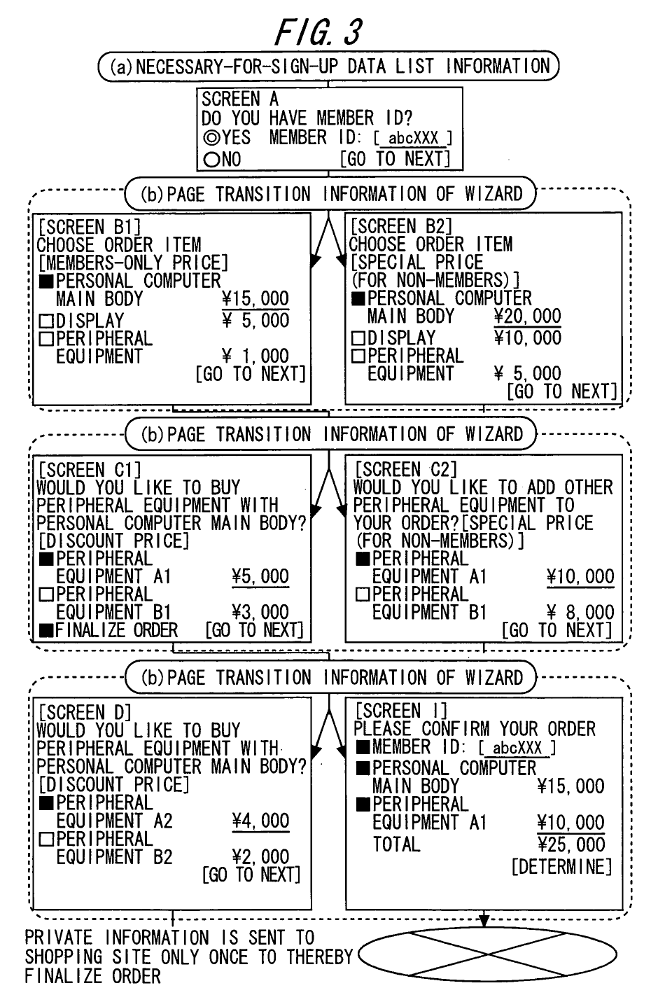

FIGS. 2 and 3 are screen transition diagrams showing a shift between transition screens displayed on the client 2. FIGS. 4 to 6 are explanatory diagrams each showing an example of information sent from the server 4 to the client 2. FIG. 4 is an explanatory diagram showing an example of information sent from the server 4 to the client 2 when a screen A, which is the initial screen, is displayed. FIG. 5 is an explanatory diagram showing an example of information sent from the server 4 to the client 2 when a screen B, which is a transition screen, is displayed. FIG. 6 is an explanatory diagram showing an example of information sent from the server 4 to the client 2 when a screen C, which is a transition screen, is displayed.

### Screen Transition Example 1: FIG. 2

The client 2 executes the secure private information transmission program to receive the necessary-for-sign-up data list information and the page transition information from the server 4. The necessary-for-sign-up data list information is information for recording private information and other sign-up information inputted through the client 2 (input information), and is held by the secure private information transmission program.

The screen A shown in FIG. 2 is a screen to judge whether a user has a member ID or not. When a user has a member ID, “Yes” is chosen whereas “No” is chosen when the user does not have a member ID. The user chooses “Yes” or “No” by manipulating a mouse or a keyboard. In desktop PCs, usually an item is selected with a click of the mouse. The screen transition example in FIG. 2 is for the case where a user has a member ID.

When a “go to next” button on the screen A is clicked on while “Yes” is selected on the screen A, screen specifying information that contains “ScreenB1.html” is sent to the server 4 from the client 2 in accordance with the branching condition contained in the page transition information of a wizard which is shown in (b) of FIG. 4. In short, Condition 1 is set to the screen A. Similarly, Condition 2 is set to the screen B1 and Condition 3 is set to a screen C1.

Receiving “ScreenB1.html” from the server 4, the client 2 displays the screen B1. With a member ID, screen specifying information that specifies a transition screen where members-only price or discount price is displayed is sent to the server 4.

When the user chooses an option of personal computer main body on the screen B2, Condition 2 shown in FIG. 5 is used and screen specifying information that contains “ScreenC1.html” is sent from the client 2 to the server 4. Receiving “ScreenC1.html”, the client 2 displays the screen C1. As a result, the choice of personal computer main body is recorded in the necessary-for-sign-up data list information. Price information may be recorded along with “personal computer main body” which is recorded in the necessary-for-sign-up data list information of the example shown in FIG. 4.

When an option of peripheral equipment is chosen on the screen C1, Condition 3 shown in FIG. 6 is used and screen specifying information that contains “ScreenD2.html” is sent from the client 2 to the server 4. Receiving “ScreenD2.html”, the client 2 displays a screen D2.

The program temporarily holds the information about whether the user has a member ID or not which is entered on the screen A by selection from options, and determines which screen is to be the destination of the next transition based on the information held. Alternatively, the information about whether the user has a member ID or not may be recorded in the necessary-for-sign-up data list information to be referred to when judging whether Condition 3 is met or not.

A user who has a member ID enters the member ID on a screen D2 and then clicks on an enter button. With the click on the enter button, the user's name and address are recorded in the necessary-for-sign-up data list information.

A user who does not have a member ID enters his/her name and address on the screen D1 using the keyboard or the like, and then clicks on an enter button. With the click on the enter button, the user's name and address are recorded in the necessary-for-sign-up data list information. The client 2 judges if all information that should be recorded in the necessary-for-sign-up data list information has been inputted. If it has, the client 2 sends the necessary-for-sign-up data list information to the server 4.

### Screen Transition Example 2: FIG. 3

While FIG. 2 shows an example of displaying the screen A on which whether a user has a member ID or not alone is entered by selection from options, FIG. 3 shows an example of screen transition subsequent to input of a member ID.

When the “go to next” button on the screen A is clicked on with a member ID entered on the screen A, screen specifying information that contains “ScreenB1.html” is sent to the server 4 from the client 2 in accordance with the branching condition contained in the page transition information of the wizard which is shown in (b) of FIG. 4. The member ID is recorded in the necessary-for-sign-up data list information with the click on the “go to next” button.

The screen specifying information that contains “ScreenB1.html” is sent to the server 4 in accordance with Condition 1 of FIG. 4 when a user has a member ID. Receiving “ScreenB1.html” from the server 4, the client 2 displays the screen B1. The member ID entered is recorded in the screen specifying information.

The secure private information transmission program uses the information recorded in the necessary-for-sign-up data list information to create “SreenE.html” while “finish sign-up” is selected on the screen C1. Then an enter button is clicked on and, after judging if all information that should be recorded in the necessary-for-sign-up data list information has been entered, the client 2 sends the necessary-for-sign-up data list information to the server 4.

As has been described, the client 2 alone keeps managing private information until the necessary-for-sign-up data list information containing the private information is transmitted, thus giving a third party no chance to intercept the private information.

### Basic Processing Procedure

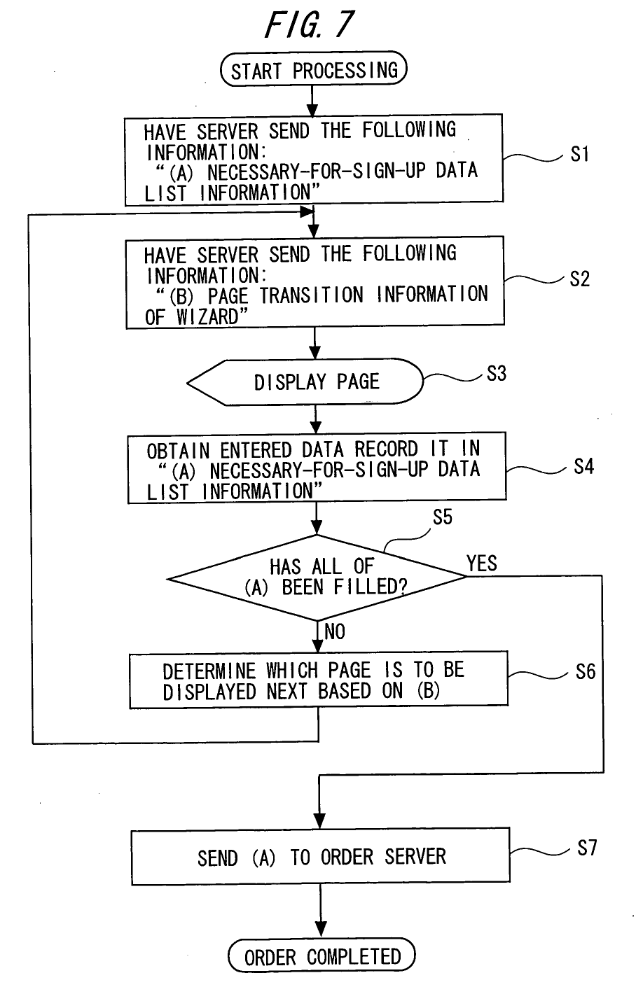

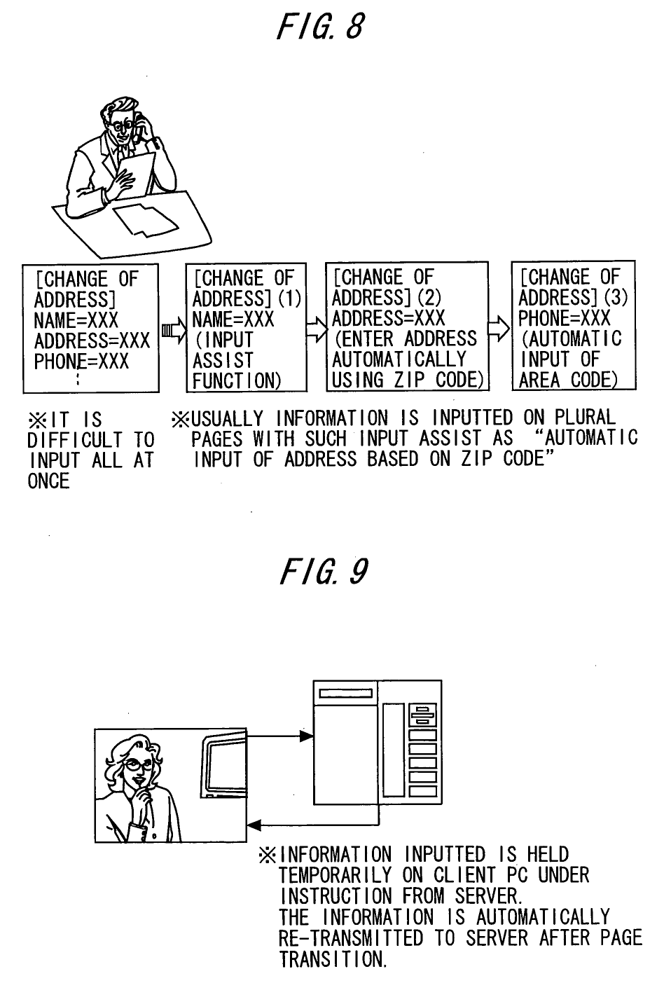

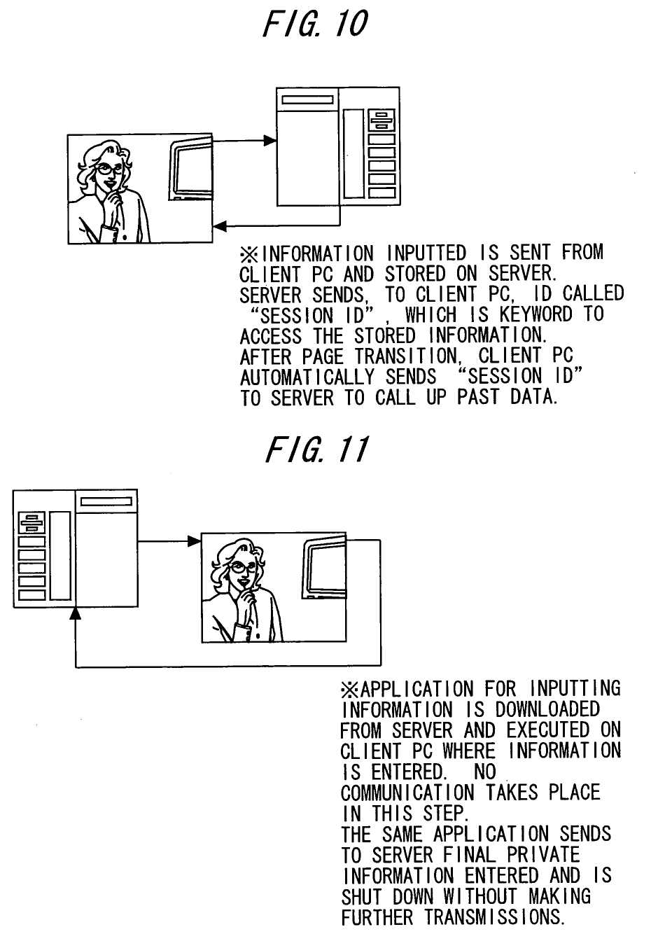

FIG. 7 is a flow chart showing a basic processing procedure of the present invention. Its description is given taking as an example a case of purchasing an article at a shopping site.

(1) A “start sign-up” button is installed on an order page of the shopping site. With a click on the button, for example, a JavaApplet (Java is a registered trademark) serving as a secure private information transmission program (hereinafter referred to as sign-up application) is read by the client 2 from the server 4 and activated on the client 2. The secure private information transmission program is not particularly limited to a JavaApplet (Java is a registered trademark) but may be a normal application, JavaScript (registered trademark) or the like.

(2) The sign-up application downloads “necessary-for-sign-up data list information” from an order server (S1). “Page transition information” is downloaded next (S2) and the URL of an entrance page (initial screen) or the like for sign-up is obtained from the server 4 to display html of a necessary page (S3). The entrance page is received from the server 4 by depressing the “start sign-up” button.

(3) A user makes an entry in each input field on the obtained page (private information such as the user's ID number, name, address and telephone number). The information entered in the input fields is recorded in the necessary-for-sign-up data list information with a click on a “go to next” button, which is located at the bottom of the page (S4).

(4) The sign-up application judges if all information that should be recorded in the necessary-for-sign-up data list information has been recorded (inputted). For instance, the sign-up application checks, as the user clicks on an enter button, whether (i) an article merchandise ordered and (ii) the user's member ID (or name or address) are recorded in the necessary-for-sign-up data list information or not to thereby judge if all information that should be recorded has been recorded (S5). In the case where no article is chosen or the member ID is missing from the entry, the sign-up application does not judge that all information that should be recorded has been recorded despite a click on the enter button.

(5) When the sign-up application judges that not all of the information that should be recorded has been recorded, the entry inputted in Step S4 is checked and a page to be displayed next is chosen based on the page transition information that has been obtained in Step S2 (S6). Steps S2 through S6 are repeatedly executed until the sign-up application judges that all information that should be recorded has been recorded.

(6) The sign-up application requests a page from the server in accordance with the page transition information and displays the page. Prompted in this manner to input, the user enters an article of choice or his/her private information. The entirety of private information and other information entered by a user exists solely on the sign-up application. Private information and other information inputted are not sent onto the network until the sign-up application judges that all information that should be recorded has been recorded.

(7) When inputting every necessary private information is finished and the sign-up application judges that all information that should be recorded has been entered, a message such as “Send sign-up information to the server 4 now?” is displayed on the display. Following user's final instruction (expressed with, for example, depression of a send button), the program sends the private information and other information which are inputted to the server 4 via the network.

(8) As the server 4 receives the final sign-up data from the client 2, the sign-up application finishes the sign-up processing. After sent to the server 4, the necessary-for-sign-up data list information may be deleted from the sign-up application irrespective of whether the sign-up application is shut down or not.

Information transmission/reception between the client 2 and the server 4 takes place several times as a characteristic of the present invention. The transmission/reception is actually unidirectional transmission from the server 4 to deliver transition screens (html pages) requested by the client 2. In other words, private information is held in the client 2 until the last transmission. Therefore no harm is done if transmission is intercepted before the necessary-for-sign-up data list information is sent from the client 2 to the server 4.

After receiving page transition information that has been sent from the server 4, the client 2 follows a branching condition contained in the page transition information and unilaterally requests, without an external input, the latest html or, if necessary, new page transition information. The client 2 autonomously chooses a transition screen based on the page transition information.

Thus “always the latest information (Web page)” is displayed on the client 2, which is a benefit of operating on the Web and which is missing from the conventional “application providing method”. The method of the present invention is particularly effective for when “it is necessary to keep providing the latest terms of use and sales system” in sign-up on a shopping site such as WEBMART.

This is because the “application providing method” could bring a shopping site into trouble with a user when there is a change in terms of use or the like for sales contract and the former version of the system is used by mistake to sign up.

In the case of price raise, for example, a user who has ordered through the former version of the system may complain about paying the higher price of the new system.

To give another example, in the case where a new service such as a reward system where a user earns points with every purchase is introduced, a user who orders through the former version of the system may complain about the site's failure of applying the reward service to his/her purchase.

With the “application providing method”, users are required to always use the newer application in order to avoid these troubles. Such service changes invariably necessitate revision of the client application provided to users. It is also necessary to build a system that negates an order that is made through the former version of the system downloaded by users in the past.

The “application providing method” requires users to download the latest client application each time the users use the shopping site, which is a hassle that burdens users. As a result, it is not uncommon that users stop using the shopping site.

The problems of the “application providing method” can be solved while improving the level of securities such as prevention of leakage of private information.

In the present invention, important information such as user's credit information is managed solely on the client 2 and the only interface is for unidirectional transmission of private information from the client 2 to the server 4.

Externally instructing the server 4 to send private information is thus made impossible. It also blocks an attempt to obtain private information by impersonation, which is possible in the conventional “session ID method”. The security level is improved as a result.

In addition, since private information is managed solely on the client 2, private information is not sent/received between the client 2 and the server 4 several times unlike the conventional “method of storing information in Cookies”. Moreover, the client 2 does not keep private information and thus the possibility of interception is eliminated.

To summarize, the present invention can provide conditions (a) “that private information is managed only on the client 2”, (b) “that Web pages to be displayed are invariably received from the server 4 the same as normal Web pages”, and (c) “that the interface that handles private information is unidirectional from the client 2 to the server 4”. Therefore stronger securities than in prior art are ensured for transmission of private information.

With the conventional “application providing method”, the application has to contain almost all “necessary-for-sign-up contents information” and accordingly is large in file size, which makes users hesitate to download the application.

The client 2 in the present invention does not need contents information or the like at all. The file size of the application according to the present invention is therefore smaller than in the conventional “application providing method”, and users can casually download the application.

Also, users can use the client 2 that is equipped with the latest security measures. Furthermore, the present invention simplifies building of a shopping site, which, as has been mentioned, needs to take various measures against interception/impersonation in addition to SSL encoding. The present invention only has to use SSL encoding when sending necessary-for-sign-up data list information.

Once necessary-for-sign-up data list information is encoded upon transmission, it is very difficult to intercept and decode the encoded necessary-for-sign-up data list information. Moreover, various processing for input assistance which is used in sign-up is run on the client 2, and the server 4 only has to send transition screens unilaterally. In short, the burden on the server 4 is lessened.

Conventionally, users often have to download the latest application of large size to replace the older one especially when a security problem or the like is found in a dedicated application. In contrast, the present invention merely requires users to download a secure private information transmission program of small size provided only for data analysis. This is effective in terms of both security and server load.

The present invention thus makes it possible to cut back security cost in shopping sites and other similar Web sites.

The secure private information transmission program of the present invention is capable of minimizing the amount of information communicated between a client PC and a server and reducing the amount of information communicated between a client PC and a server.

What is claimed is:

1. A secure private information transmission program readable by a computer, comprising the steps of:
receiving first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and
determining screen specifying information which specifies the second transition screen based on the branching condition and information inputted on the first transition screen.

2. The secure private information transmission program according to claim 1, further comprising a step of entering application information as input information on the first transition screen.

3. The secure private information transmission program according to claim 1, further comprising a step of transmitting the screen specifying information that is determined by the determining step.

4. The secure private information transmission program according to claim 1, wherein the receiving step receives second transition screen information that is specified by the screen specifying information.

5. The secure private information transmission program according to claim 2, further comprising a step of holding application information that is entered on the first transition screen.

6. The secure private information transmission program according to claim 1, wherein the receiving step receives necessary-for-application data list information, which contains private information for identifying a user.

7. The secure private information transmission program according to claim 5, wherein the holding step holds application information by recording, in necessary-for-application data list information, application information that is entered on the first transition screen.

8. The secure private information transmission program according to claim 4, further comprising a step of requesting transmission of screen transition information that corresponds to the second transition screen information.

9. The secure private information transmission program according to claim 2, wherein the input step inputs application information by selecting from options or in a descriptive manner on the first transition screen.

10. The secure private information transmission program according to claim 3, further comprising a step of judging if inputting necessary-for-application data list information is finished, and wherein when the judging step judges that inputting necessary-for-application data list information is finished, the transmitting step sends the necessary-for-application data list information.

11. The secure private information transmission program according to claim 5, wherein necessary-for-application data list information held in the holding step is deleted when the secure private information transmission program is shut down.

12. A secure private information transmission apparatus comprising:
a receiving unit receiving first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and
a determining unit determining screen specifying information which specifies the second transition screen based on the branching condition and information inputted on the first transition screen.

13. A secure private information reception program readable by a computer, comprising the steps of:
transmitting first transition screen information and screen transition information, the first transition screen information being for displaying a first transition screen prior to screen transition, the screen transition information containing a branching condition and screen specifying information, which specifies a second transition screen to be shifted after satisfying the branching condition on the first transition screen; and
receiving screen specifying information which specifies the second transition screen determined based on the branching condition and information inputted on the first transition screen.

14. The secure private information reception program according to claim 13, wherein the transmitting step transmits second transition screen information that is specified by the screen specifying information.

15. The secure private information reception program according to claim 13, wherein the transmitting step transmits necessary-for-application data list information, which contains private information for identifying a user.

16. The secure private information reception program according to claim 13, wherein the transmitting step sends screen transition information that corresponds to the second transition screen information.

17. The secure private information reception program according to claim 13, wherein the receiving step receives, only once, necessary-for-application data list information sent by the transmitting step.

18. A secure private information receiving apparatus comprising:
a transmitting unit transmitting first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and
a receiving unit receiving screen specifying information which specifies the second transition screen determined based on the branching condition and information inputted on the first transition screen.

19. The secure private information transmission apparatus according to claim 18, wherein the transmitting unit transmits second transition screen information that is specified by the screen specifying information.

20. The secure private information transmission apparatus according to claim 18, wherein the transmitting unit transmits necessary-for-application data list information, which contains private information for identifying a user.

21. The secure private information receiving apparatus according to claim 19, wherein the transmitting unit sends screen transition information that corresponds to the second transition screen information.

22. The secure private information receiving apparatus according to claim 18, wherein the receiving unit receives, only once, necessary-for-application data list information sent by the transmitting unit.

23. A secure private information reception method comprising the steps of:
transmitting first transition screen information and screen transition information, the first transition screen information being for displaying a first transition screen prior to screen transition, the screen transition information containing a branching condition and screen specifying information which specifies a second transition screen to be shifted after satisfying the branching condition on the first transition screen; and
receiving screen specifying information which specifies the second transition screen determined based on the branching condition and information inputted on the first transition screen.
